(19) United States
(12) Patent Application Publication
(10) Pub. No.: US 2014/0285031 A1
(43) Pub. Date: Sep. 25, 2014

(54) POWER ON/OFF CONTROL SYSTEM AND POWER ON/OFF CONTROL METHOD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YI-LIANG LI, Wuhan (CN); SHU-QI WU, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/063,145

(22) Filed: Oct. 25, 2013

(30) Foreign Application Priority Data
Mar. 22, 2013 (CN) 2013100936549

(51) Int. Cl. H01H 43/00

(52) U.S. Cl. CPC H01H 43/00
USPC 307/116

(57) ABSTRACT

A power on/off control system includes a microcontroller, a setting module connected to the microcontroller, a photoelectric coupler connected to the microcontroller, and a relay connected to the microcontroller. The setting module is used to set parameters, and the parameters include a power-on time and a power-off time. The relay is used to receive alternating current and connected to an electronic device. When the power-on time is ended, the microcontroller is used to send a power-off signal to the photoelectric coupler for turning on the relay, and the relay stops supplying power to the electronic device. When the power-off time is ended, the microcontroller is further configured to send a power-on signal to the photoelectric coupler for turning off the relay, to supply power for the electronic device. The disclosure further offers a power on/off control method.

### BACKGROUND

1. Technical Field

The present disclosure relates to power on/off control systems, and particularly to a power on/off control system and a power on/off control method for an electronic device.

2. Description of Related Art

Nowadays, electronic devices, such as computers, mobile phones, are used in daily life. Sometimes, the electronic devices need to be powered on or powered off in turn, and it laborious and tired in manual work. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block diagram of a power on/off control system in accordance with an embodiment.

FIG. 2 is a detailed circuit diagram of a power supply module of the power on/off control system of FIG. 1.

FIG. 3 is a detailed circuit diagram of a control module of the power on/off control system of FIG. 1.

FIG. 4 is a detailed circuit diagram of a displaying module of the power on/off control system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

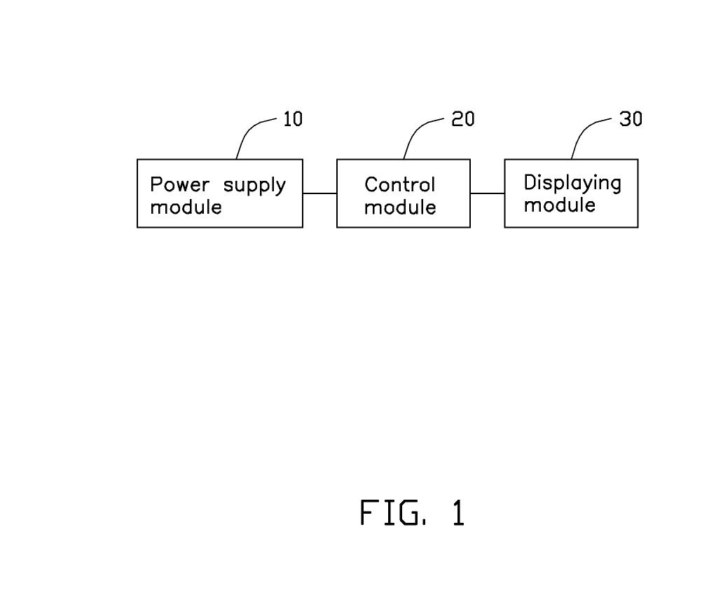

FIG. 1 illustrates a power on/off control system in accordance with an embodiment. The power on/off control system comprises a power supply module 10, a control module 20 connected to the power supply module 10, and a displaying module 30 connected to the control module 20.

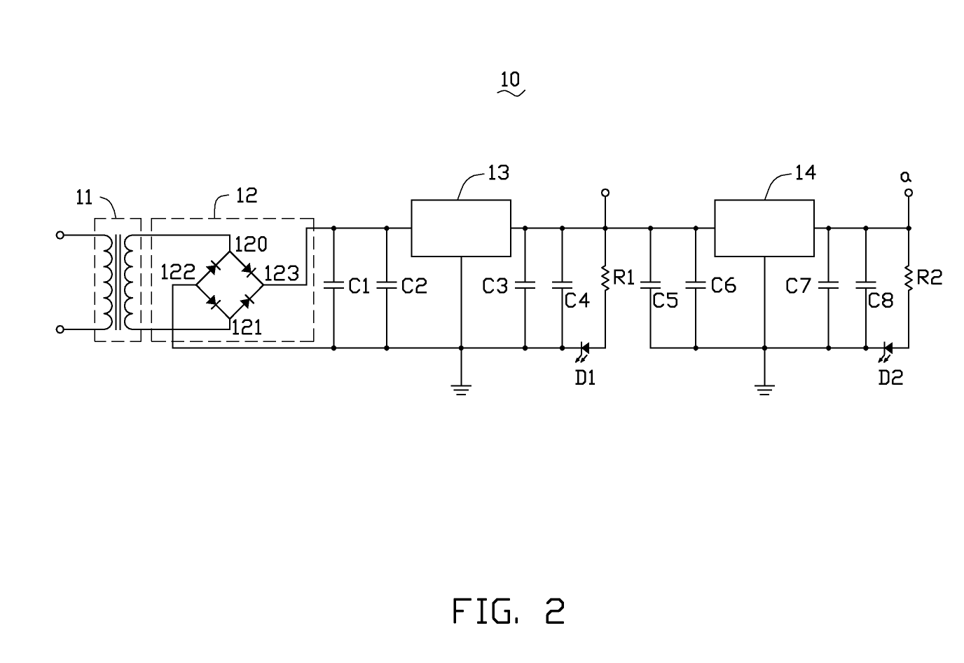

FIG. 2 illustrates the power supply module 10 of the power on/off control system in accordance with an embodiment. The power supply module 10 comprises transformer 11, a rectifier bridge 12 connected to the transformer 11, a first stabilized voltage supply 13 connected to the rectifier bridge 12, and a second stabilized voltage supply 14 connected to the first stabilized voltage supply 13. The transformer 11 is used to receive a 220V alternating current (AC). The rectifier bridge 12 comprises four connecting terminals 120, 121, 122, 123. The connecting terminals 120, 121 are connected to the transformer 11. The connecting terminal 122 is grounded. The connecting terminal 123 is connected to an input terminal of the first stabilized voltage supply 13. The connecting terminal 123 is further connected to a first capacitor C1 and a second capacitor C2. A first terminal of the first capacitor C1 is connected to the input terminal of the first stabilized voltage supply 13, and a second terminal of the first capacitor C1 is grounded. A first terminal of the second capacitor C2 is connected to the input terminal of the first stabilized voltage supply 13, and a second terminal of the second capacitor C2 is grounded. A ground pin of the first stabilized voltage supply 13 is grounded.

An output terminal of the first stabilized voltage supply 13 is connected to an input terminal of the second stabilized voltage supply 14. A first terminal of a third capacitor C3 is connected to the output terminal of the first stabilized voltage supply 13, and a second terminal of the third capacitor C3 is grounded. A first terminal of the fourth capacitor C4 is connected to the output terminal of the first stabilized voltage supply 13, and a second terminal of the fourth capacitor C4 is grounded. The output terminal of the first stabilized voltage supply 13 is connected to a positive of a diode D1 via a resistor R1, and a negative of the diode D1 is grounded.

A first terminal of a fifth capacitor C5 is connected to the input terminal of the second stabilized voltage supply 14, and a second terminal of the fifth capacitor C5 is grounded. A first terminal of a sixth capacitor C6 is connected to the input terminal of the second stabilized voltage supply 14, and a second terminal of the sixth capacitor C6 is grounded. A first terminal of a seventh capacitor C7 is connected to the output terminal of the second stabilized voltage supply 14, and a second terminal of the seventh capacitor C7 is grounded. A first terminal of an eight capacitor C8 is connected to the input terminal of the second stabilized voltage supply 14, and a second terminal of the eighth capacitor C8 is grounded. The output terminal of the first stabilized voltage supply 14 is connected to a positive of a diode D2 via a resistor R2, and a negative of the diode D2 is grounded. The transformer 11 is used to change the 220V AC to a 12V AC. The rectifier bridge 12 is used to change the 12V AC to a 16V direct current (DC). The first stabilized voltage 13 is used to change the 16V DC to a 12V DC. The second stabilized voltage 14 is used to change the 12V DC to 5V DC.

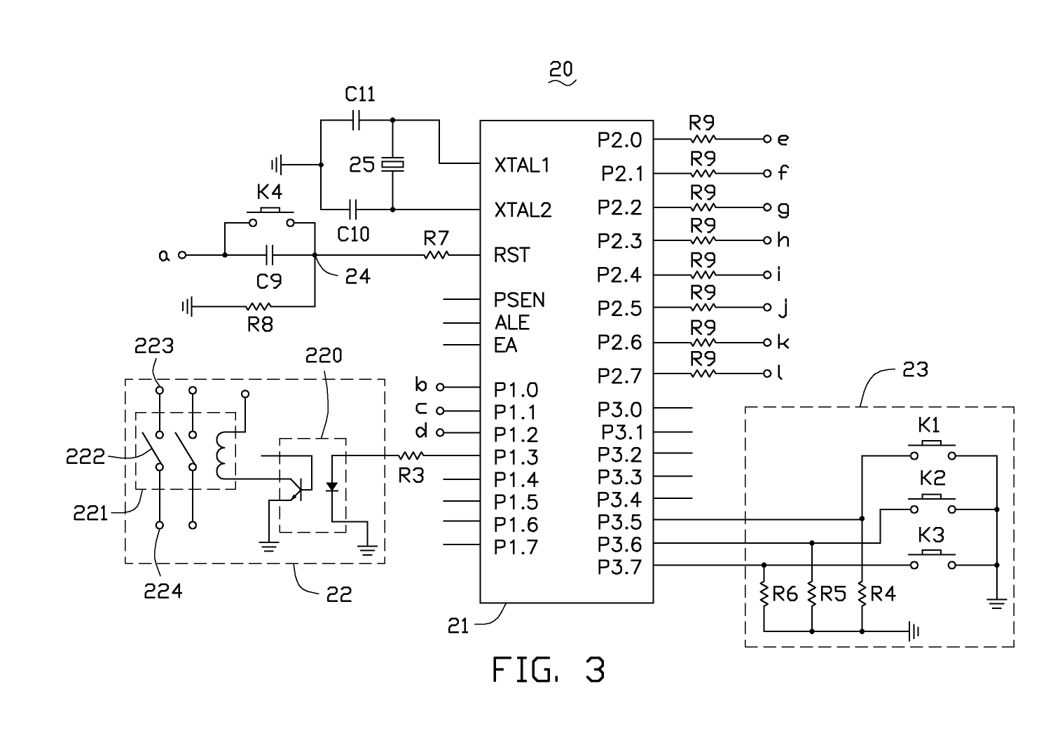

FIG. 3 illustrates the control module 20 of the power on/off control system in accordance with an embodiment. The control module 20 comprises a microcontroller 21, a switch device 22 is connected to the microcontroller 21, and a setting module 23 is connected to the microcontroller 21. The pin P3.5 of the microcontroller 21 is grounded via a switch K1 and is further connected to the 5V DC via a resistor R4. The pin P3.6 of the microcontroller 21 is grounded via a switch K2 and further connected to the 5V DC via a resistor R5. The pin P3.7 of the microcontroller 21 is grounded via a switch K3 and further connected to the 5V DC via a resistor R6. The pin EA of the microcontroller 21 is connected to the 5V DC. The pin RST of the microcontroller 21 is connected to a first node 24 via a resistor R7. The first node 24 is connected to the 5V DC via a ninth capacitor C9 and further connected to the 5V DC via a switch K4. The first node 24 is grounded via a resistor R8. The pin XTAL 2 is connected to a tenth capacitor C10, and the tenth capacitor C10 is grounded. The pin XTAL 1 is connected to an eleventh capacitor C11, and the eleventh capacitor C11 is grounded. A quartz oscillator 25 is connected to the pin XTAL 1 and the pin XTAL 2.

The switch device 22 comprises a photoelectric coupler 220 and a relay 221 connected to the photoelectric coupler 220. The positive of the light-emitting diode (LED) of the photoelectric coupler 220 is connected to a pin P1.3 of the microcontroller 21 via a resistor R3. The negative of the LED of the photoelectric coupler 220 is grounded. The emitter of a phototransistor of the photoelectric coupler 220 is grounded. The collector of the phototransistor of the photoelectric coupler 220 is connected to a first terminal of the relay 221, and a second terminal of the relay 221 is connected to the 12V DC. A first terminal 223 of each switch 222 of the relay 221 is connected to AC (not shown), and a second terminal 224 of each switch 222 of the relay 221 is connected to an electronic device (not shown), such as a computer.

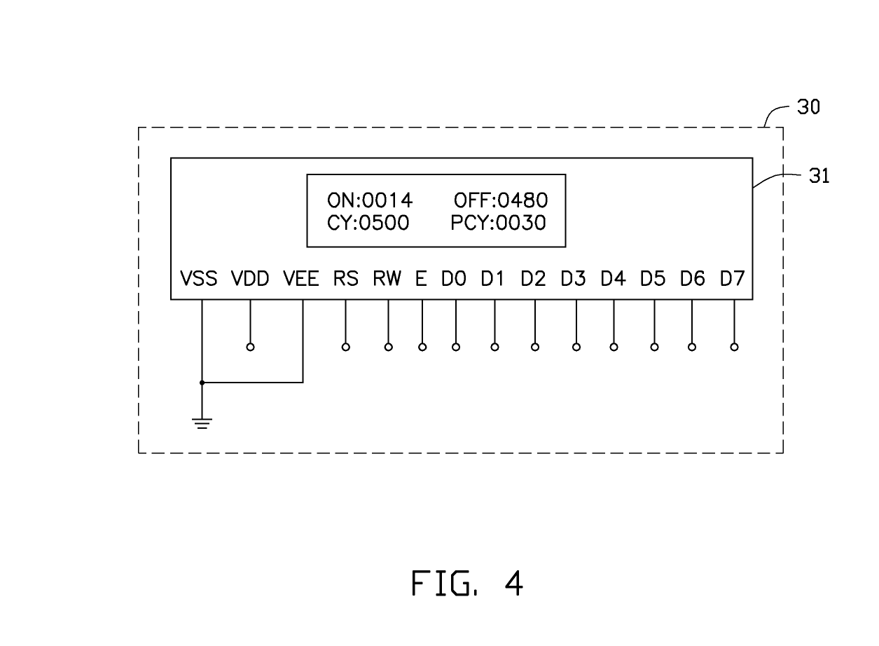

FIG. 4 illustrates the displaying module 30 of the power on/off control system in accordance with an embodiment. The displaying module 30 comprises a display 31. The pin VSS of the displayer 31 is grounded. The pin VDD of the displayer 31 is connected to a 5V DC. The pins RS, RW, E of displayer 31 are connected to the pins P1.0, P1.1, P1.2 of the microcontroller 21, respectively. The pins D0, D1, D2, D3, D4, D5, D6, D7 of the displayer 31 are connected to the pins P2.0, P2.1, P2.2, P2.3, P2.4, P2.5, P2.6, P2.7 of the microcontroller 21, respectively.

In use, when the switch K1 is pressed, the pin P3.5 of microcontroller 21 is grounded via the switch K1, and the control module 21 is located in a setting mode. Thus, the parameters, comprising a conduction time (ON), a power-off time (OFF), a power on/off time (CY), and a total of the power on/off time (PCY) of the displayer 31, can be set by the displayer 31. A value of each parameter can be set in a range of 0000-9999. The switch K1 is pressed repeatedly, and the order of the ON-OFF-CY-PCY can be changed. The switch K2 is pressed, the pin P3.6 of the microcontroller is grounded via the switch K2. The parameters can be set repeatedly 0-9 times via pressing the switch K2. The switch K3 is pressed, the pin P3.7 of the microcontroller is grounded via the switch K3. When the parameters are set, the conduction time (ON) is completed by the switch K3, and a high level ‘1’ is output by the pin P1.3 of the microcontroller 21. The LED of the photoelectric coupler 220 is lit, so that the phototransistor of the photoelectric coupler 220 is switched on. Thus, a coil of the relay 221 is powered on to generate magnetism, to turn on the switch 27 of the relay 221. The OFF is completed by the switch K3, and a low level ‘0’ is output by the pin P1.3 of the microcontroller 21. The LED of the photoelectric coupler 220 stopping lighting, so that the phototransistor of the photoelectric coupler 220 is switched off. Thus, the coil of the relay 221 is powered off, and magnetism is not in the relay 221, to turn off the switch 27 of the relay 221. At this time, the electronic device is powered off to count the OFF. When the ON is set, a low level ‘0” is output by the microcontroller 21, and the relay 221 stops supplying power to the electronic device and start the OFF. When the OFF is set, a high level ‘1” is output by the microcontroller 21, and the relay 221 supplies power to the electronic device and start the ON. The ON and the OFF are set repeatedly, until the total of the PCY is equal to a predetermined total of the PCY.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A power on/off control system comprising:
a microcontroller;
a setting module connected to the microcontroller; the setting module is configured to set parameters, the parameters comprising a power-on time and a power-off time;
a photoelectric coupler connected to the microcontroller; and
a relay connected to the microcontroller; the relay is configured to receive alternating current and configured to connected to an electronic device;
wherein when the power-on time is ended, the microcontroller is configured to send a power-off signal to the photoelectric coupler for turning on the relay, and the relay stops supplying power to the electronic device; and when the power-off time is ended the microcontroller is further configured to send a power-on signal to the photoelectric coupler for turning off the relay, to supply power for the electronic device.

2. The power on/off control system of claim 1, wherein a positive of a light-emitting diode of the photoelectric coupler is connected to the microcontroller via a first resistor, the negative of the light-emitting diode of the photoelectric coupler is grounded; a first terminal of a coil of the relay is connected to a connector of a phototransistor of the photoelectric couple, a second terminal of the coil of the relay is connected a first direct current, and an emitter of the phototransistor of the photoelectric couple is grounded.

3. The power on/off control system of claim 1, wherein the setting module comprises a first switch, a second switch, and a third switch, the first switch is configured to switchover the power-on time and the power-off time, the second switch is configured to set the parameter when the power-on time and the power-off time are switchovered by the first switch the third switch is configured to ensure the parameter is set by the second switch; the microcontroller comprises a first pin, a second pin, and a third pin, the first pin is grounded via the first switch, the second pin is grounded via the second switch, and the third pin is grounded via the third switch.

4. The power on/off control system of claim 3, wherein the first pin is connected to a second direct current via a second resistor, the second pin is connected to the second direct current via a third resistor, and the third pin is connected to the second direct current via a fourth resistor.

5. The power on/off control system of claim 1, wherein the microcontroller comprises a pin XTAL 1 and a pin XTAL 2, the pin XTAL 1 is connected to a first capacitor, the first capacitor is grounded, the pin XTAL 2 is connected to a second capacitor, and the second capacitor is grounded.

6. The power on/off control system of claim 5, further comprising a quartz oscillator, wherein the quartz oscillator is connected to the pin XTAL 1 and the pin XTAL 2.

7. The power on/off control system of claim 4, wherein the microcontroller further comprises a pin RST, the pin RST is connected to a first node via a fifth resistor, and the first node is connected to the second direct current via a third capacitor.

8. The power on/off control system of claim 7, wherein the first node is connected the second direct current via a fourth switch.

9. The power on/off control system of claim 7, wherein the first node is grounded via a sixth resistor.

10. The power on/off control system of claim 1, further comprising a displaying module connected to the microcontroller, wherein the parameters further comprises a power on/off time and a total of the power on/off time, and the displaying module is configured to display the parameters.

11. A power on/off control method comprising:
setting parameters by a setting module, and the parameters comprising a power-on time and a power-off time;
receiving alternating current by a relay connected to an electronic device;
sending a power-off signal to a photoelectric coupler for turning on the relay by a microcontroller connected to the relay, and stopping supplying power to the electronic device when the power-on time is ended; and
sending a power-on signal to the photoelectric coupler for turning off the relay by the microcontroller, and supplying power to the electronic device when the power-off time is ended.

12. The power on/off control method of claim 11, wherein a positive of a light-emitting diode of the photoelectric coupler is connected to the microcontroller via a first resistor, the negative of the light-emitting diode of the photoelectric coupler is grounded; a first terminal of a coil of the relay is connected to a connector of a phototransistor of the photoelectric couple, a second terminal of the coil of the relay is connected a first direct current, and an emitter of the phototransistor of the photoelectric couple is grounded.

13. The power on/off control method of claim 11, wherein the setting module comprises a first switch, a second switch, and a third switch, the first switch is configured to switchover the power-on time and the power-off time, the second switch is configured to set the parameter when the power-on time and the power-off time are switchovered by the first switch, the third switch is configured to ensure the parameter is set by the second switch; the microcontroller comprises a first pin, a second pin, and a third pin, the first pin is grounded via the first switch, the second pin is grounded via the second switch, and the third pin is grounded via the third switch.

14. The power on/off control s method of claim 13, wherein the first pin is connected to a second direct current via a second resistor, the second pin is connected to the second direct current via a third resistor, and the third pin is connected to the second direct current via a fourth resistor.

15. The power on/off control method of claim 11, wherein the microcontroller comprises a pin XTAL 1 and a pin XTAL 2, the pin XTAL 1 is connected to a first capacitor, the first capacitor is grounded, the pin XTAL 2 is connected to a second capacitor, and the second capacitor is grounded.

16. The power on/off control method of claim 15, further comprising a quartz oscillator, wherein the quartz oscillator is connected to the pin XTAL 1 and the pin XTAL 2.

17. The power on/off control method of claim 14, wherein the microcontroller further comprises a pin RST, and the pin RST is connected to a first node via a fifth resistor, and the first node is connected to the second direct current via a third capacitor.

18. The power on/off control method of claim 17, wherein the first node is connected the second direct current via a fourth switch.

19. The power on/off control method of claim 17, wherein the first node is grounded via a sixth resistor.

20. The power on/off control method of claim 11, further comprising a displaying module connected to the microcontroller, wherein the parameters further comprises a power on/off time and a total of the power on/off time, and the displaying module is configured to display the parameters.
